(19) United States
(12) Patent Application Publication
(10) Pub. No.: US 2011/0257924 A1
(43) Pub. Date: Oct. 20, 2011

(54) SELF-MONITORING AND COMMUNICATING TRANSFORMER

(75) Inventors: Gregory A. Bryant, Laurel, MS (US); Richard Hollingsworth, Ellisville, MS (US); Samuel A. Impastato, Laurel, MS (US); Yu-Loong Liew, Hattiesburg, MS (US); Allen John Thiel, III, Laguna Niguel, CA (US); Joe James Salazar, Carlsbad, CA (US)

(73) Assignees: Southern California Edison, Rosemeade, CA (US); Howard Industries, Inc., Laurel, MS (US)

(21) Appl. No.: 12/764,061

(22) Filed: Apr. 20, 2010

(51) Int. Cl. G06F 19/00; G06F 15/00

(52) U.S. Cl. 702/122; 702/130

(57) ABSTRACT

A self-monitoring transformer is disclosed. The transformer uses sensors embedded in the coils to determine the expected lifespan of the insulation, as well as other operating parameters, and communicates that information to an external system.

### FIELD OF THE INVENTION

The present invention is generally directed toward a transformer that can monitor and communicate its own status. Specifically, it is directed toward a transformer that can estimate the remaining life of its insulation and alert a utility company before the transformer insulation deteriorates to the point of failure.

### BACKGROUND OF THE INVENTION

Distribution transformers are used by utility companies to step down the high-voltage carried in the power lines to a safer level, such as 120 V or 240 V, that can be used by consumers. These transformers have a high-voltage side, consisting of external high-voltage bushings, that are connected to an internal high-voltage coil. These transformers also have a low-voltage side, consisting of external low-voltage bushings that are connected to one or more internal low-voltage coils. A magnetic core passes through the window of the high-voltage coil and also passes through the window of the low-voltage coil, magnetically coupling the two, and providing a voltage reduction function between the high-voltage and low-voltage coils. The internal low-voltage coil is connected to external low-voltage bushings where the customer's power feed is connected.

The high-voltage and low-voltage coils are typically wound on top of one another, separated by insulation material. The insulation is also wound within the high-voltage and low-voltage coils to isolate adjacent turns of conductor from each other. This insulation is subject to high internal temperatures of the transformer, and, over time, thermal stress will cause the insulation to degrade. Eventually, the insulation will reach the end of its useable life, and the transformer will fail, resulting in power outages or other damage.

There is no easy method for a utility company to determine how much thermal stress a transformer has experienced in the field. Each transformer is subject to different conditions that affect the amount of heat to which it is exposed, including ambient temperature, the amount of shade or direct sunlight, wind exposure, and loading. Due to the varying factors, it is difficult to know the thermal stress on each transformer.

Currently, regularly scheduled replacement of the transformers is done as a preventative measure against transformer failure. However, replacing the transformers is a time-consuming process, and it is not cost effective to replace one that is not close to the end of its lifespan.

A need exists for transformers that can monitor various operating parameters and communicate their status, including total insulation degradation.

### SUMMARY OF THE INVENTION

The presently disclosed device is a transformer that has the capability to monitor various temperatures inside and outside the transformer, to calculate the expected aging or deterioration of the transformer's insulation based on those measurements, and to communicate that data (as well as potentially many other pieces of information about the transformer, the power line, and ambient conditions) to an external system.

### BRIEF DESCRIPTION OF THE DRAWINGS

Further advantages of the invention will become apparent by reference to the detailed description of preferred embodiments when considered in conjunction with the drawings:

FIG. 1 illustrates a perspective view of an embodiment of a pole-mount version of the device.

FIG. 2 depicts the pass through connector for connecting the circuitry and communication wiring to the transformer.

FIG. 3 shows data collected during verification testing of an embodiment.

FIG. 4 also shows data collected during verification testing of an embodiment.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

Increases in heat inside a transformer, due to loading, ambient temperature, or other factors, accelerate the deterioration of the insulation materials in the transformer. The disclosed device is a transformer that can obtain several temperature readings which are used to determine the temperature at the hottest spot of the transformer and the expected remaining insulation life.

The hottest spot will typically be inside the high-voltage coil of the transformer. Because of the high voltage potential, a temperature sensor cannot easily be embedded in the high-voltage coil. However, the temperature at this location can be extrapolated using a thermal model of the transformer which was developed through laboratory experimentation.

To develop the thermal model, a coil assembly was wound with many temperature sensors embedded throughout the low-voltage and high-voltage coils in various locations. This coil was then incorporated into a test transformer. A low-voltage, full current heat run test was performed on the transformer to generate heat in the transformer as if it were fully loaded. Coil resistance readings were also taken before and after the heat run test. This data was analyzed to determine the value of the hottest spot temperature in the coils and the location of the hottest spot in the coils. Additionally, the low-voltage coil temperature sensor that most closely matched the hottest spot temperature was identified and an extrapolation equation was developed to correct the most closely matched low-voltage coil sensor to the actual hottest spot temperature.

Using this thermal model and temperature readings from sensors embedded in the low-voltage coils, the temperature at the high-voltage coil can be extrapolated. In a preferred embodiment, a T-type thermocouple is embedded in each of the two low-voltage coils, close to the high-voltage coil, while the coils of the transformer are being wound. The thermocouple wires are routed out of the coils and connected to a terminal strip with copper and constantan terminals matching the thermocouple wire material. Other types of thermal sensors, for example, resistive thermal devices, could also be used for greater accuracy.

The device also obtains temperature readings near the top of the oil in the tank, as well as the ambient temperature outside the transformer. Sensing the temperatures of both low-voltage coils, the top-oil, and the ambient is not essential, but having all of those temperature measurements available improves the ability to accurately determine the hottest-spot temperature in the transformer.

Once the hottest-spot temperature is determined for one sample period, the incremental insulation aging over the sample interval can be calculated by using the formula presented in Section 5 of IEEE Std C57.91-1995, “IEEE Guide for Loading Mineral-Oil-Immersed Transformers,” herein incorporated by reference. According to the formula, the life of the transformer insulation is dependent upon the hottest spot temperature and the value of coefficients, which may be selected by an end-user as configurable options. A running sum of these incremental aging factors is stored in memory by the disclosed device to calculate the amount of insulation life used and the amount of insulation life remaining.

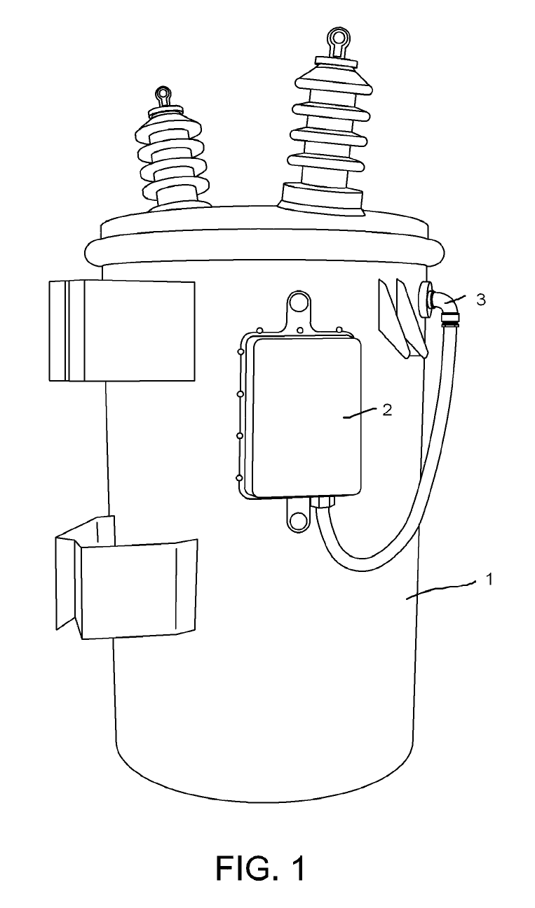

The circuitry for the disclosed device is housed in an enclosure that is mounted to the outside of a single phase pole-mounted transformer tank, as depicted in FIG. 1. Alternatively, it could be mounted within the transformer itself. Similar circuitry can be used with single-phase or three-phase pad-mounted type transformers and mounted in the “air compartment” of the transformer where the power leads are connected.

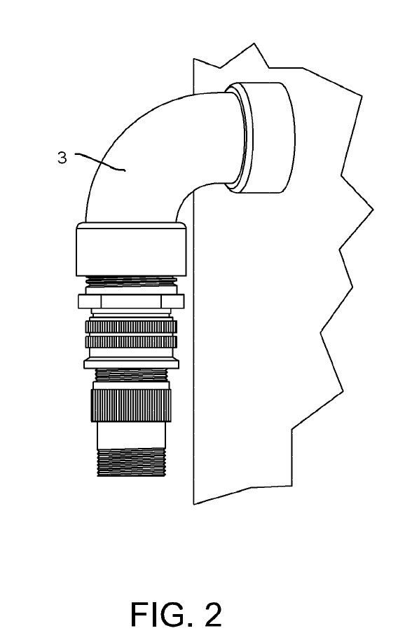

Because the transformer tanks are filled with oil, the wires from the thermal sensors must pass through a sealed feed-through port, as depicted in FIG. 2. This port prevents the oil from leaking out of the transformer. Other embodiments could use a screw-on connector in place of the sealed feed-through port.

The circuitry also includes means to communicate the data from the transformer. A communication port is included on the circuit board to report this data to an external system such as a utility company's DCS (Data Collection System) or SCADA (Supervisory Control and Data Acquisition) using the industry standard DNP3 protocol. In a preferred embodiment, a radio is used for communicating the information. However, other means, such as fixed wireless and powerline networking, could be used to transmit the information.

The disclosed device can also monitor and transmit additional information to the external system. For example, the circuit board can measure and report the secondary voltage of the transformer. Utility companies can use this information to ensure that the voltage regulator in the substation, which feeds the transformer, is operating properly and is programmed properly. Excessively high or low voltages indicate a problem with the voltage regulator operation and/or programming and can cause problems with customers' equipment, as well as violating the utility's power service limits for its customers.

Current and watt metering capabilities can also be added to the circuit board so that the device can detect theft of power or monitor the transformer's loading. The transformer with these capabilities would meter all of the power drawn from it and report that information to the utility's DCS. The utility company can, then, compare the power metered by the circuit board to the sum of the readings of all of the customer power meters fed by that transformer. If the transformer's reading is significantly higher than the customer meters, it is likely that someone has bypassed a meter and is stealing power. With the addition of power metering, the circuit board will also be able to report the current being drawn, the power factor, and the KVA, KVAR, and watt-hour readings.

Other sensors could be connected to the transformer circuit board, such as oil level switches, pressure switches, and temperature switches. This would allow the circuit board to send messages to the DCS based on the status of the switches.

Super capacitors with high energy storage capacity are used to keep the circuit board powered for over a minute in the event of a power failure. This ability allows the circuit board to send a message to the utility's DCS or SCADA system, notifying it that there is a power failure on the electrical grid and indicating the location of the power outage. Through widespread use of the disclosed transformer devices, the utility could get power failure messages from many transformers, clearly identifying the size and location of the outage area, making identifying and repairing the point of failure easier.

### Example 1

As can be seen in FIG. 1, circuit boards were installed in a non-metallic enclosure 1 mounted to the outside surface of a 75 KVA single-phase pole-type transformer 2. LANDIS+GYRR brand radio boards were installed in enclosure 1 and connected to the circuit board to provide communications. Three T-type thermocouple wire pairs connect to terminals on the circuit board and exit enclosure 1 via flexible conduit. As can be seen in FIG. 2, the wires pass through the tank wall via a sealed feed-through port 3 in the transformer tank wall and connect to a terminal strip mounted inside the transformer tank above oil level. The wires are connected to a thermocouple wound into each of the two low-voltage coils of the transformer and to a top-oil thermocouple secured close to the top-oil level near the center of the tank. Two voltage sense/power wires are also connected to terminals on the circuit board and pass through the conduit and sealed feed-through port 3 to the terminal strip inside the transformer tank. From there, the wires connect to the center low-voltage bushing and one other bushing, connecting on the back of the terminal inside the tank, to provide power to the circuit board and allow the board to detect the secondary voltage.

Another T-type thermocouple extends out of the circuit board enclosure 1 to measure ambient temperature. A thermally sensitive transistor is on the circuit board near the terminal strip where the thermocouples connect to the board to measure the temperature of the connection point for performing cold junction compensation on the thermocouple readings.

In this embodiment, the circuit board is a microprocessor-controlled electronic circuit board with RMS voltage measurement capability and T-type thermocouple measurement circuits. The firmware on the circuit board must take periodic samples of the thermocouple temperatures and use the low-voltage coil temperatures, along with the top-oil temperature and ambient temperature, to calculate the temperature of the hottest spot in the transformer based on a mathematical model developed through experimental data. The hottest spot temperature is, then, used in the IEEE insulation aging formula to calculate the amount of insulation aging that occurred during the sample interval. The circuit board keeps a running sum of the insulation aging experienced to date. This data can, then, be communicated via the radio board to the SCADA or DCS system so that replacement or maintenance can be performed before the insulation has degraded to the point of failure.

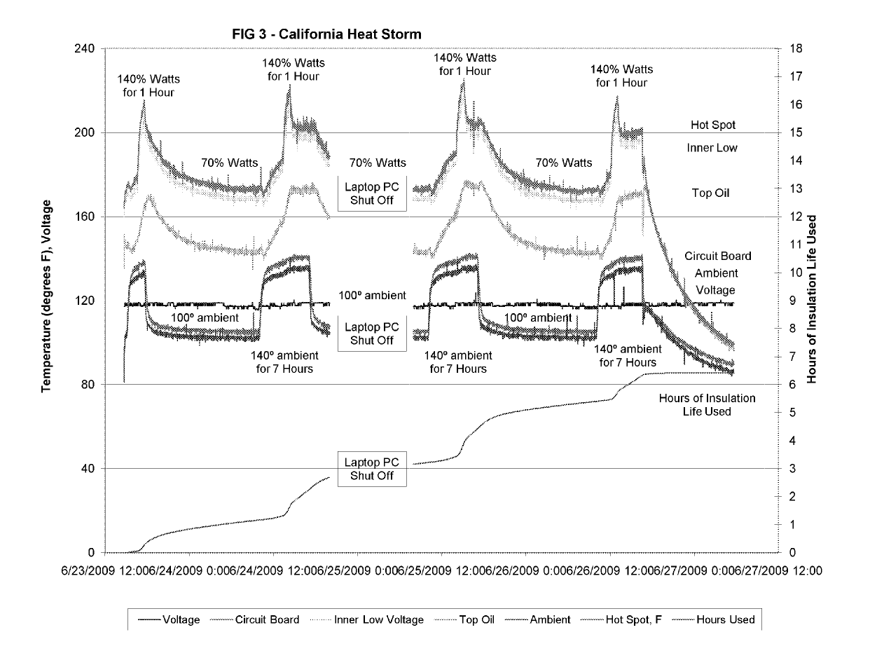

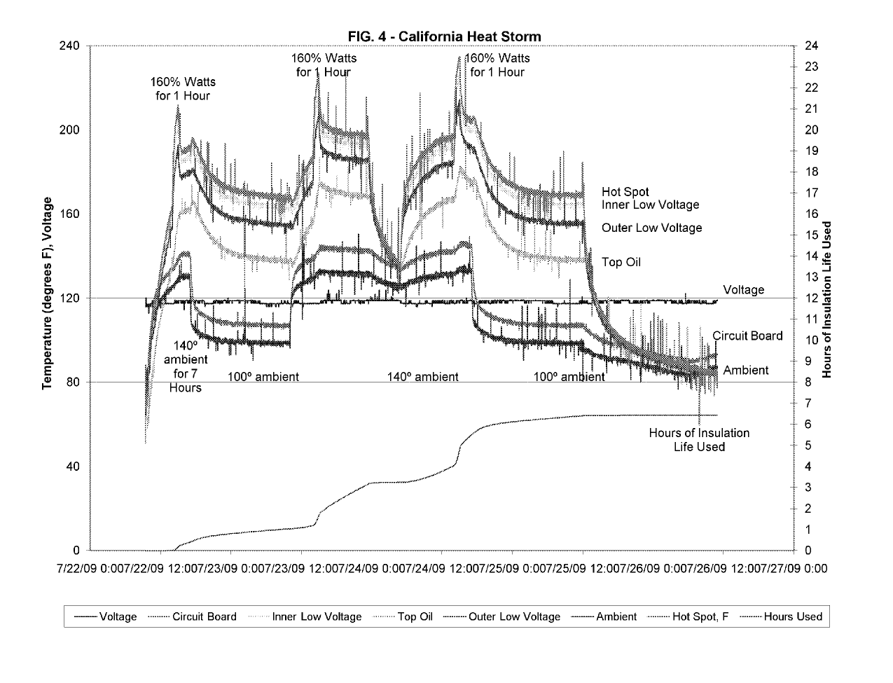

FIG. 3 and FIG. 4 present actual data from thermal cycle tests that verified the operation of the disclosed device and its ability to withstand elevated ambient temperatures.

In one embodiment, voltage is only sensed on one side of the split secondary of the transformer. These units have three low-voltage bushings on them. The voltage from the center bushing to either of the outer bushings is 120 V, and, between the two outer bushings, it is 240 V. In an alternative embodiment, a second voltage measurement channel could be added to the circuit board, and both halves of the secondary of the transformer could be monitored. This will provide additional information about the loading of the transformer and other possible operational data.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques, other than those specifically described herein, can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A self-monitoring transformer comprising:
a. a transformer;
b. internal temperature sensors;
c. circuitry for estimating remaining insulation life; and
d. a communication interface.

2. The device of claim 1 further comprising an external temperature probe.

3. The device of claim 1 further comprising storage medium for retention of data.

4. The device of claim 1 further comprising a radio transmitter for communicating status.

5. The device of claim 1 wherein at least one of said internal temperature sensors is embedded in a transformer coil.

6. The device of claim 1 further comprising a high energy storage capacitor.

7. A self-monitoring transformer comprising:
a. a transformer;
b. internal thermal sensors; and
c. circuitry for monitoring operating conditions.

8. The device of claim 7 further comprising an external temperature probe.

9. The device of claim 7 further comprising storage medium for storage of data.

10. The device of claim 7 further comprising a radio transmitter for communicating operating conditions.

11. The device of claim 7 further comprising circuitry for communicating with a network.

12. The device of claim 7 wherein at least one of said internal temperature sensors is embedded in a transformer coil.

13. The device of claim 7 further comprising a high energy storage capacitor.

14. A self-monitoring transformer comprising:
a. a thermal sensor embedded in the low-voltage coil;
b. circuitry to extrapolate the temperature at the transformer's hottest spot;
c. circuitry to calculate insulation aging data; and
d. means for transmitting said insulation aging data.

15. The device of claim 14 wherein said means for transmitting said insulation aging data is radio.

16. The device of claim 14 further comprising voltage sensors.

17. The device of claim 14 further comprising high energy storage capacitors.

18. The device of claim 14 further comprising data storage means.

19. The device of claim 14 further comprising oil level sensors.

20. The device of claim 14 further comprising a temperature switch.

21. The device of claim 14 further comprising a pressure switch.
